(19) United States
(12) Patent Application Publication
(10) Pub. No.: US 2007/0276699 A1
(43) Pub. Date: Nov. 29, 2007

(54) Method of Acquiring Data

(76) Inventors: Cornelius Meyer De Villiers, Claremont (ZA); Dirk Jacobus, Welgemoed (ZA)

Correspondence Address: STITES & HARBISON PLLC, 1199 NORTH FAIRFAX STREET, SUITE 900, ALEXANDRIA, VA, 22314, US

(21) Appl. No.: 10/559,673

(22) PCT Filed: Jun. 5, 2004
(86) PCT No.: PCT/IB04/50844

§ 371 Date: Dec. 18, 2006

(30) Foreign Application Priority Data
Jun. 6, 2003 (ZA) 2003/4426

(51) Int. Cl. G06Q 50/00

(52) U.S. Cl. 705/3

(57) ABSTRACT

The invention discloses a method of acquiring, storing and transmitting data, which includes the provision of a database having at least three record sets in which data, such as medical examination data, can be accurately stored in suitable numerical format.

### FIELD OF INVENTION

The present invention relates to a method of acquiring data.

More particularly, the present invention relates to a method of acquiring data by means of numerical conversions.

### BACKGROUND TO INVENTION

When medical doctors examine patients, they normally do so by following a routine which they have developed through experience. The routines of various doctors thus vary depending on which area of medicine they have specialized in and what type of experience they have gained.

After each examination of a patient, a doctor should write a report on his findings and diagnosis of the patient. This enables the doctor to record a history of the medical problems of a patient. If the patient should change to a second doctor, or if the patient is referred to a second doctor for specialist treatment, then it is preferable that the second doctor knows the medical history of the patient.

Currently there is no mechanism by which a patient's medical history can be reliably stored or transferred to a second doctor. Thus every doctor expends a certain amount of time re-diagnosing the patient, before treating the patient. This is time wasting and may result in an incorrect diagnosis of a patient's medical condition.

It is an object of the invention to suggest a method of acquiring data, which will assist in overcoming these problems.

### SUMMARY OF INVENTION

According to the invention, a method of acquiring data includes the steps of
a) providing a first record set including a first unique number associated with a first person; a second unique number associated with a second person; a third unique number associated with a specific question, contained in a list of questions; and a fourth number being an answer to the specific question;
b) providing a second record set associated with the first record set, the second record set including a question code associated with the third unique number; and a statistical weight to be given to the fourth number,
c) providing a third record set associated with the second record set, the third record set including a description reference of the question code; and
d) saving the first record set, the second record set, and the third record set in a database.

A method of acquiring data includes the steps of
a) providing a first record set including a first unique number associated with a first person; a second unique number associated with a second person; a third unique number associated with a specific question, contained in a list of questions; and a fourth number being an answer to the specific question;
b) providing a second record set associated with the first record set, the second record set including a question code associated with the third unique number; and a statistical weight to be given to the fourth number;
c) providing a third record set associated with the second record set, the third record set including a description reference of the question code;
d) saving the first record set, the second record set, and the third record set in a database; and
e) providing a fourth record set identifying financial data.

Any of the first record set, the second record set, the third record set, the fourth record set or the entire database may be able to be jointly or separately transmitted to wherever required.

The first person may be a medical practitioner.

The first number may be associated with the medical practitioner's national registration number.

The first number may be associated with the medical practitioner's specialist qualifications and experience.

The second number may include a check digit calculated by means of the Lunz method.

The second person may be a medical patient.

The fourth number may be adapted to indicate a true or false answer to a question associated with the third number.

The first record set may include a fifth number associated with a date and time that the first person examined the second person.

The first record set may include a sixth number adapted to be a check digit for verifying the validity of any other number contained in the first record set.

The second record set may include a list of third unique numbers associated with all possible questions that can be asked.

Each third unique number may be associated with at least one further third unique number associated with a question which should be asked or answered.

Each third unique number may be associated with at least one further third unique number associated with a question which need not be asked or answered.

The third record set may include a reference to a publication containing a description of the question code.

The fourth record set may include three unique numbers.

The three unique numbers may be associated with a budgeted item, a budgeted value, and availability of funds.

The budgeted item may be a type of treatment or medication required by the second person.

The budgeted value may be a cost associated with the type of treatment or medication.

The availability of funds may be retrieved from the second person's medical aid or bank account to cover the costs indicated by the budgeted value.

### BRIEF DESCRIPTION OF DRAWINGS

The invention will now be described by way of example with reference to the accompanying schematic drawings.

In the drawings there is shown in:

FIG. 1 a first record set provided by the method of acquiring data in accordance with the invention;

FIG. 2 a second record set provided by the method in accordance with the invention;

FIG. 3 a third record set provided by the method in accordance with the invention; and

FIG. 4 a fourth record set provided by the method in accordance with the invention.

### DETAILED DESCRIPTION OF DRAWINGS

The method of acquiring data in accordance with the invention requires a person, such as a medical doctor, to make a hypothesis as to a possible medical diagnosis regarding a patient. The doctor is required to answer a select group of questions relating to that diagnosis. In order to answer the questions, the doctor may have to conduct simple tests on the patient.

The questions are asked in a structured format, each question requiring a true or false answer. The number and type of questions which are asked may be increased or reduced depending on the answers given by the doctor to a specific question. The questions may even lead to the doctor making a new or second hypothesis as to the possible medical diagnosis.

As each new hypothesis is made, they are placed in a queue for processing after the current hypothesis has been fully processed.

The information obtained from by the method is stored in a database in a specific format (as will be described hereafter) and any other doctor, such as a specialist doctor, will be able to follow the first doctor's medical analysis by studying this information. The medical history of the patient will be contained in the information and will thus be known to a specialist doctor.

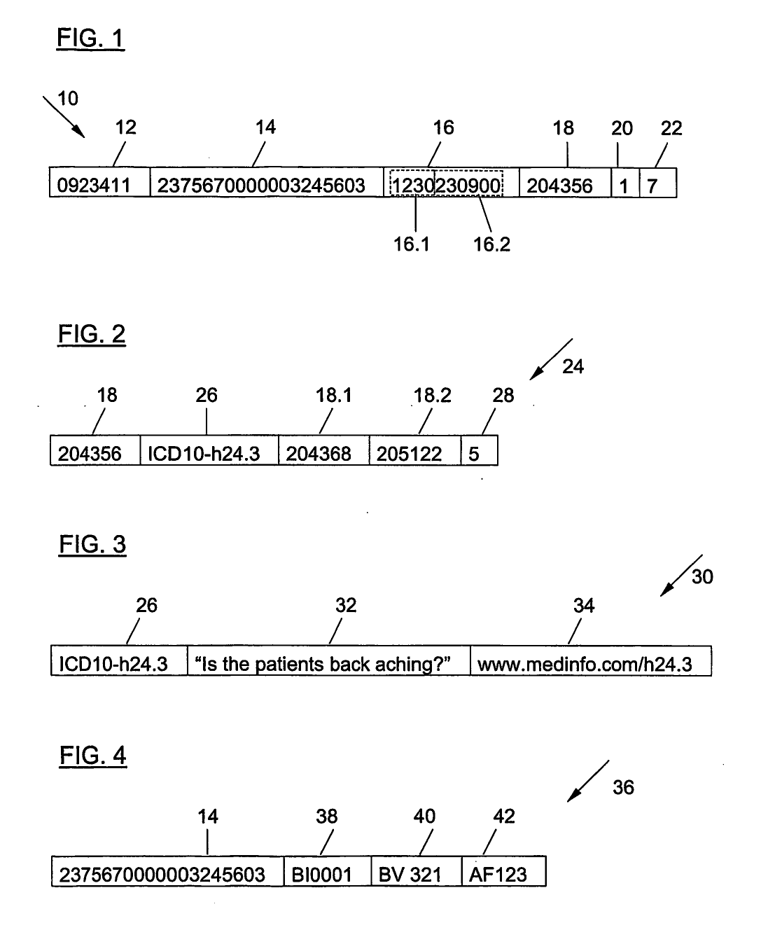

The information relating to a hypothesis is stored in the database as various record sets as is shown in FIGS. 1 to 4 of the drawings.

Referring to FIG. 1, a first record set, generally indicated by reference numeral 10, is shown. The first record set 10 includes a first or doctor identification number 12, a second or patient identification number 14, a date and time 16, a third or question number 18 and a fourth or answer number 20 given to the question number 18.

The first record set 10 can also include a check digit 22, which determines whether all the other numbers 12,14,16,18,20 contained in the record set 10 are correctly represented or if a problem has developed due to loss of characters or human error in copying the numbers 12,14,16,18,20.

The doctor identification number 12 is used to identify which doctor used the method in testing a hypothesis. Each doctor registered to practice in a country, in which the method is to be used, is allocated an individual identification number 12 which is identical to or can be derived from their national registration number. The doctor identification number 12 is further used to indicate whether or not the doctor has any specialist qualifications. This allows control of the quality and responsibility of the doctor and also which referrals should be made to other doctors.

The patient identification number 14 is a unique number given to each patient who is analysed by the method. The last digit in the patient identification number 14 is a check digit, which is calculated by the Lunz method, and enables the patient identification number 14 to be verified.

The date and time 16 is entered automatically, the time 16.1 being entered in twenty-four hour time format and the date 16.2 being entered in short date format

The question number 18 is a unique number given to each possible question asked in the method. The question number 18 is never re-used, even if a question is deleted or redefined. The question number 18 is related to a second record set 24, which stores all the questions together with rule base information associated with the questions, as shown in FIG. 2.

The second record set 24 relates the question identification number 18 with a code description 26 of the question, with any further question associated with a question identification number 18.1 that should also be asked of the doctor, with any question associated with a question identification number 18.2 that need not be asked of the doctor, as well as with a statistical weight 28, which should be applied to the answer of the question associated with the question identification number 18.

If necessary, the code description 26 can be related to a third record set 30, as shown in FIG. 3, which either provides a description 32 of the question asked, or can be linked to publication details of a publication giving a description of the question asked. The publication can be a printed publication or it can be a publication provided on the internet. The publication will preferably contain details of the origin and reason for asking the question associated with a question identification number 18.

The answer number 20 can be associated with a true (1) or false (0) answer, or it can be a number indicating a level of severity, e.g. of damage sustained during burn wounds.

The use of the first record set 10 enables a hypothesis to be made and stored in a secure manner, which contains detailed information in a structured format that can be easily researched. As the information is defined by numerical characters, it is also easily transferable to other medical practitioners.

This method is thus also applicable for simultaneous real-time analysis of the information by many medical practitioners. As such the method is extremely viable for use in highly specialised operations, which require practitioners that are situated in different countries.

The method also incorporates the use of a fourth record set 36, as shown in FIG. 4, for financial data. The patient identification number. 14 is associated with a budgeted item number 38, with a budget value number 40 and with an availability of funds number 42. Thus should the patient require cost incurring treatment or medication, the doctor will be able to enter the type of treatment or medication in the budgeted item number 38 and the applicable cost will then be entered in the budgeted value number 40. The budgeted value number 40 can either be manually entered by the doctor or it can be automatically entered from the database. The database then electronically queries the medical aid service or the bank account of the patient to determine if the patient has sufficient funds to cover the relevant costs.

From a security aspect, the use of the information returned by the fourth record set 36 can be restricted to prevent fraudulent activity. Thus the patient may be required to enter a secret pin code or to provide certain biometric data with a biometric data identification card to verify his identity. The biometric data can be a finger print.

The database and/or any of the various record sets can be jointly or separately sent to wherever they are required to be used, for example the database can be sent from a general practitioner to a specialist doctor for further use. Also, the second record set 24 and the third record set 30 can be updated from time to time as additional information or products are made available and as further research is conducted in the relevant medical field.

The method described above can also be used as a learning tool or as a grading tool whereby experienced doctors can judge the knowledge of inexperienced doctors. This is done by determining how many hypothesis were made and comparing these to the final diagnosis made of the patient. As the inexperienced doctor gains experience, the number of hypothesis made will or should decrease before a correct final decision is made.

1. A method of acquiring data includes the steps of providing a first record set including a first unique number associated with a first person; a second unique number associated with a second person; a third unique number associated with a specific question, contained in a list of questions; and a fourth number being an answer to the specific question;
providing a second record set associated with the first record set, the second record set including a question code associated with the third unique number; and a statistical weight to be given to the fourth number;
providing a third record set associated with the second record set, the third record set including a description reference of the question code; and
saving the first record set, the second record set, and the third record set in a database.

2. A method as claimed in claim 1, which includes the step of providing a fourth record set identifying financial data.

3. A method as claimed in claim 1, in which any of the first record set, the second record set, the third record set or the entire database are able to be jointly or separately transmitted to wherever required.

4. A method as claimed in claim 1, in which the first person is a medical practitioner.

5. A method as claimed in claim 4, in which the first number is associated with the medical practitioner's national registration number.

6. A method as claimed in claim 4, in which the first number is associated with the medical practitioner's specialist qualifications and experience.

7. A method as claimed in claim 1, in which the second number includes a check digit calculated by means of the Lunz method.

8. A method as claimed in claim 1, in which the second person is a medical patient.

9. A method as claimed in claim 1 in which the fourth number is adapted to indicate a true or false answer to a question associated with the third number.

10. A method as claimed in claim 1, in which the first record set includes a fifth number associated with a date and time that the first person examined the second person.

11. A method as claimed in claim 1 in which the first record set includes a sixth number adapted to be a check digit for verifying the validity of any other number contained in the first record set.

12. A method as claimed in claim 1 in which the second record set includes a list of third unique numbers associated with all possible questions that can be asked.

13. A method as claimed in claim 12, in which each third unique number is associated with at least one further question which should be asked or answered.

14. A method as claimed in claim 12, in which each third unique number is associated with at least one further question which need not be asked or answered.

15. A method as claimed in claim 1, in which the third record set includes a reference to a publication containing a description of the question code.

16. A method as claimed in claim 2, in which the fourth record set includes three unique numbers.

17. A method as claimed in claim 16, in which the three unique numbers are respectively associated with a budgeted item, a budgeted value, and availability of finds.

18. A method as claimed in claim 17, in which the budgeted item is a type of treatment or medication required by the second person.

19. A method as claimed in claim 18, in which the budgeted value is a cost associated with the type of treatment or medication.

20. A method as claimed in claim 19, in which the availability of funds is retrieved from the second person's medical aid or bank account to cover the costs indicated by the budgeted value.

21. (canceled)
